(19) United States
(12) Patent Application Publication
(10) Pub. No.: US 2009/0213583 A1
(43) Pub. Date: Aug. 27, 2009

(54) LED Module

(75) Inventors: Kun-Jung CHANG, Kaohsiung County (TW); Ching-Yuan Juan, Kaohsiung County (TW); Kuo-Chun Lin, Kaohsiung County (TW); Ching-Huang Juan, Kaohsiung County (TW)

Correspondence Address: FRENKEL & ASSOCIATES, 3975 UNIVERSITY DR., STE. 330, FAIRFAX, VA, 22030, US

(73) Assignee: Li-Hong Technological Co., Ltd., Kaohsiung County (TW)

(21) Appl. No.: 12/038,047

(22) Filed: Feb. 27, 2008

(51) Int. Cl. F21V 29/00

(52) U.S. Cl. 362/218

(57) ABSTRACT

The present invention discloses an LED (Light Emitting Diode) module, which comprises: a plurality of LED lamps, baseplates, heat-conduction blocks, heat-conduction elements, and fixing elements. The LED lamp has an electrode plate on one side and an LED on the other side. One face of the electrode plate has two electrodes respectively arranged in two edges. A protection ring annularly surrounds the LED. The baseplate is a printed circuit board having a plurality of through-holes and cascade circuits on one side. The heat-conduction block is a metal block having an appropriate thickness and a high thermal conductivity and is attached to one side of the electrode plate to dissipate the heat generated by the LED lamps. The heat-conduction block has a plurality of fixing holes. The fixing elements are fastened into the fixing holes to join together the heat-conduction block and the baseplate. The heat-conduction element is a heat-conduction body attached to the other side of the heat-conduction block.

### FIELD OF THE INVENTION

The present invention relates to an LED module, particularly to an LED module, wherein cascade circuits on the baseplate are used to increase the brightness of LED lamps.

### BACKGROUND OF THE INVENTION

Refer to FIG. 1 for a conventional LED module. In the conventional LED module, LED lamps A10 are directly soldered onto a PCB (Printed Circuit Board) A20. The conventional technology is found to have the following disadvantages:

1. In the conventional LED module, the LED lamp A10 is directly soldered onto the PCB A20. In other words, the heat source of the LED lamp A10 directly contacts the PCB A20. Thus, not only heat is hard to dissipate, but also it may overheat and damage the LED lamp A10.

2. In the conventional LED module, the PCB A20 has circuits A30 where the LED lamp A10 is soldered. The circuit A30 usually has a height of about several millimeters. After the LED lamp A10 is soldered onto the PCB A20, there is a gap of several millimeters between the LED lamp A10 and the PCB A20. An electric fan can blow air into the gap to dissipate heat. However, a gap of only several millimeters is unlikely to dissipate heat fast and effectively.

### SUMMARY OF THE INVENTION

The primary objective of the present invention is to provide an LED module superior to the conventional ones and use a design of cascade circuits to enhance the brightness of LED lamps.

To achieve the abovementioned objective, the present invention proposes an LED (Light Emitting Diode) module, which comprises: a plurality of LED lamps, a plurality of baseplates, a plurality of heat-conduction blocks, a plurality of heat-conduction elements, and a plurality of fixing elements. The LED lamp has an electrode plate on one side thereof and has an LED on the other side thereof. One face of the electrode plate has two electrodes respectively arranged in two edges thereof. A protection ring annularly surrounds the LED. The baseplate is a PCB (Printed Circuit Board) having circuits thereon. The baseplate has a plurality of via-holes, and the LED lamps are inlaid into the via-holes. The baseplate has cascade circuits on one side thereof to cascade the LED lamps to enhance brightness. The baseplate also has a plurality of through-holes, and the fixing elements are inserted through the through-holes to fasten the baseplate to the heat-conduction block. The heat-conduction block is a metal block having an appropriate thickness and a high thermal conductivity. The heat-conduction block is attached to one side of the electrode plate of the LED lamps and functions as a heat-conduction medium to dissipate the heat generated by the LED lamps. The heat-conduction block has a plurality of fixing holes, and the fixing elements are fastened into the fixing holes to join together the heat-conduction block and the baseplate. The heat-conduction element is a heat-conduction body containing a heat-conduction liquid and attached to the other side of the heat-conduction block. A plurality of heat-dissipation fins is installed in one side of the heat-conduction element to dissipate the heat received by the heat-conduction element from the heat-conduction block. Two electrodes of the electrode plate are spaced by an appropriate distance, and the heat-conduction block is accommodated therebetween. Therefore, the width of the heat-conduction block is equal to the distance between two electrodes. Because the LED lamp is inlaid into the via-hole, the inner diameter of the via-hole is slightly greater than the outer diameter of the protection ring of the LED lamp.

### BRIEF DESCRIPTION OF THE DRAWINGS

FIG. 1 is a diagram schematically showing a conventional technology.

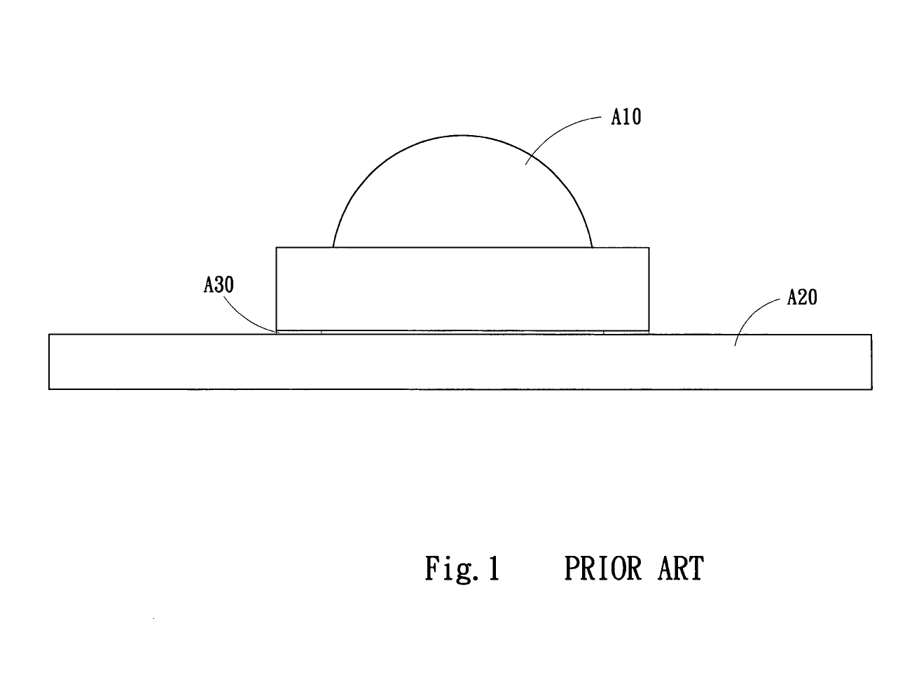

FIG. 2 is a perspective exploded view of an LED module according to the present invention.

FIG. 3 is another perspective exploded view of an LED module according to the present invention.

FIG. 4 is a perspective view of the assembly of an LED module according to the present invention.

FIG. 5A is another perspective view of the assembly of an LED module according to the present invention.

FIG. 5B is a sectional view along Line 5B-5B in FIG. 5A.

FIG. 6 is a diagram schematically showing cascade circuits on a baseplate according to the present invention.

FIG. 7 is a perspective exploded view of a heat-conduction element according to another embodiment of the present invention

FIG. 8 is another perspective exploded view of a heat-conduction element according to another embodiment of the present invention.

FIG. 9 is a perspective view of the assembly of a heat-conduction element according to another embodiment of the present invention.

FIG. 10A is another perspective view of the assembly of a heat-conduction element according to another embodiment of the present invention.

FIG. 10B is a sectional view along Line 10B-10B in FIG. 10A.

FIG. 11 is a perspective view schematically showing that a heat-conduction element with heat-dissipation fins according to further another embodiment of the present invention.

FIG. 12 is another perspective view schematically showing that a heat-conduction element with heat-dissipation fins according to further another embodiment of the present invention.

### DETAILED DESCRIPTION OF THE PREFERRED EMBODIMENTS

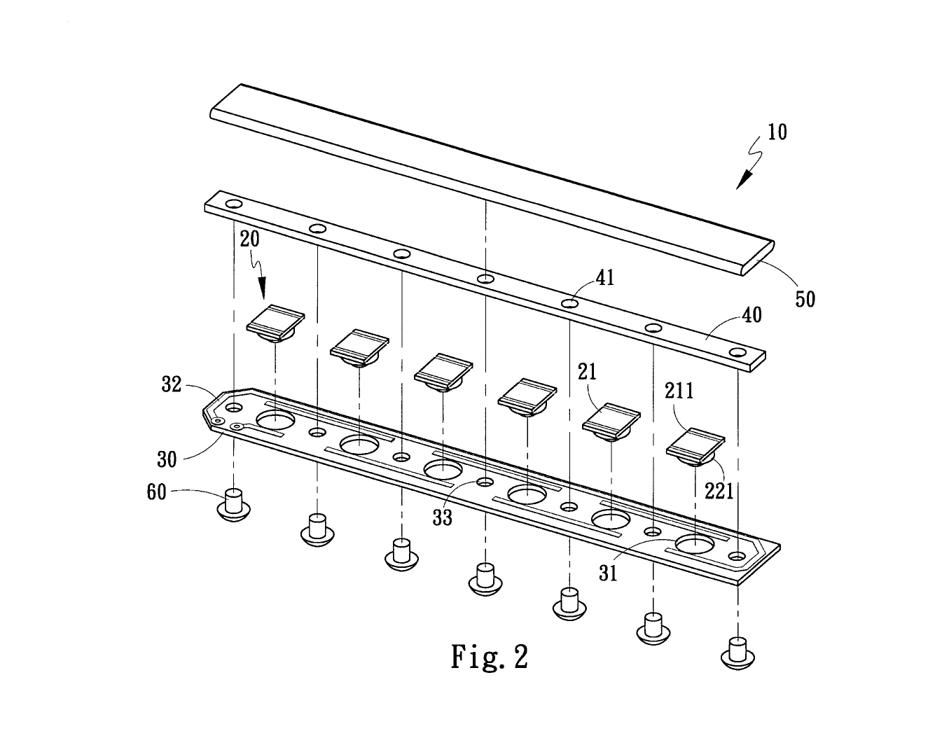

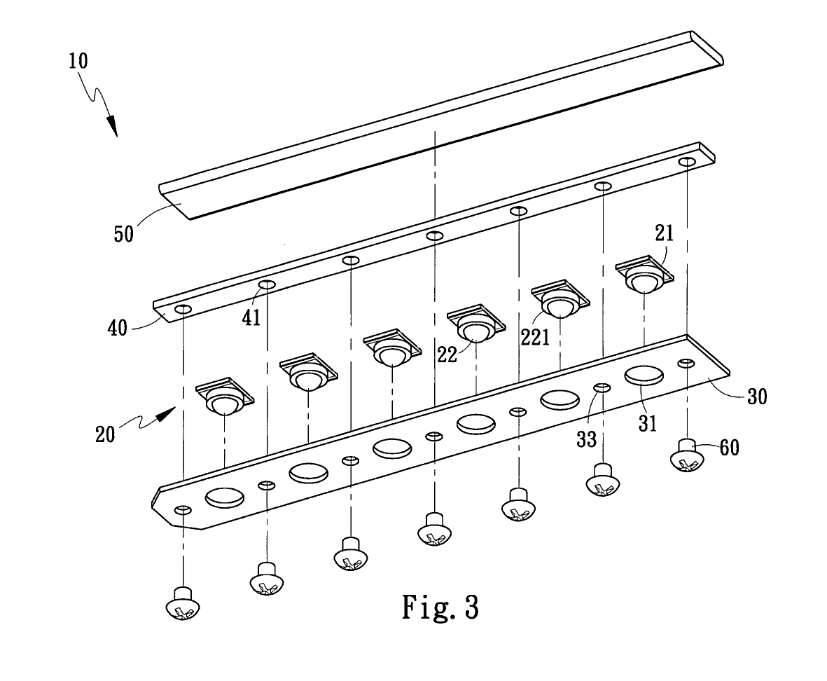

Refer to FIG. 2 and FIG. 3. The present invention discloses an LED (Light Emitting Diode) module 10, which comprises: a plurality of LED lamps 20, a plurality of baseplates 30, a plurality of heat-conduction blocks 40, a plurality of heat-conduction elements 50, and a plurality of fixing elements 60. The LED lamp 20 has an electrode plate 21 on one side thereof and has an LED 22 on the other side thereof. One face of the electrode plate 21 has two electrodes 211 respectively arranged in two edges thereof. A protection ring 221 annularly surrounds the LED 22. The baseplate 30 is a PCB (Printed Circuit Board) having circuits thereon. The baseplate 30 has a plurality of via-holes 31, and the LED lamps 20 are inlaid into the via-holes 31. The baseplate 30 has cascade circuits 32 to cascade the LED lamps 20 to enhance brightness. The baseplate 30 also has a plurality of through-holes 33, and the fixing elements 60 are inserted through the through-holes 33 to fasten the baseplate 30 to the heat-conduction block 40. The heat-conduction block 40 is a metal block having an appropriate thickness and a high thermal conductivity. The heat-conduction block 40 is attached to one side of the electrode plate 21 of the LED lamps 20 and functions as a heat-conduction medium to dissipate the heat generated by the LED lamps 20. The heat-conduction block 40 has a plurality of fixing holes 41, and the fixing elements 60 are fastened into the fixing holes 41 to join together the heat-conduction block 40 and the baseplate 30. The heat-conduction element 50 is a heat-conduction body containing a heat-conduction liquid and attached to the other side of the heat-conduction block 40. The heat-conduction element 50 is also used to dissipate heat. Two electrodes 211 of the electrode plate 21 are spaced by an appropriate distance, and the heat-conduction block 40 is accommodated therebetween. Therefore, the width of the heat-conduction block 40 is equal to the distance between two electrodes 211. Because the LED lamp 20 is inlaid into the via-hole 31, the inner diameter of the via-hole 31 is slightly greater than the outer diameter of the protection ring 221 of the LED lamp 20. The cascade circuits 32 may be made of aluminum and may be arranged on one side of both sides of the baseplate 30.

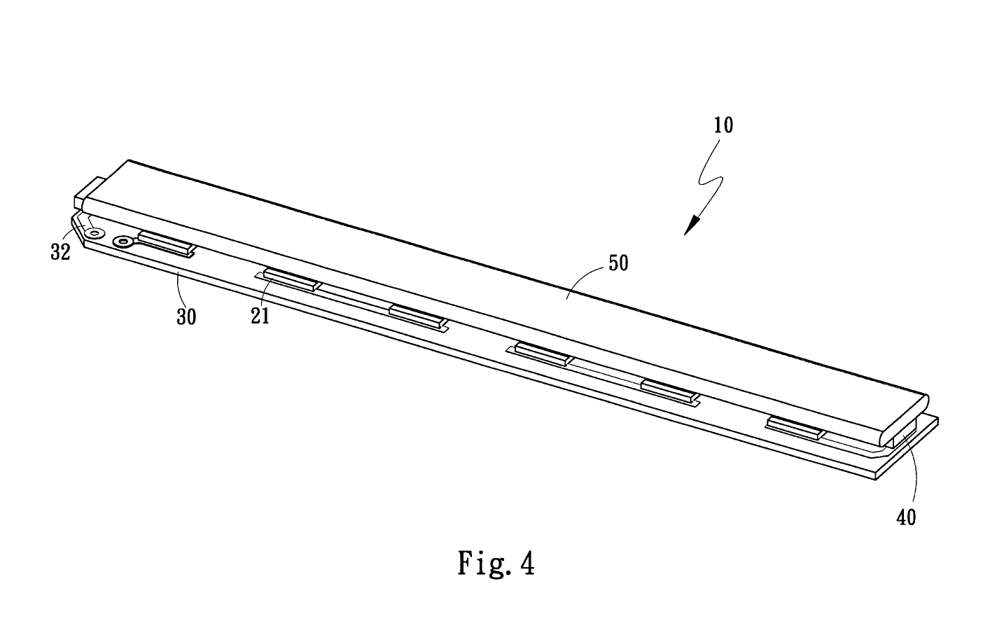

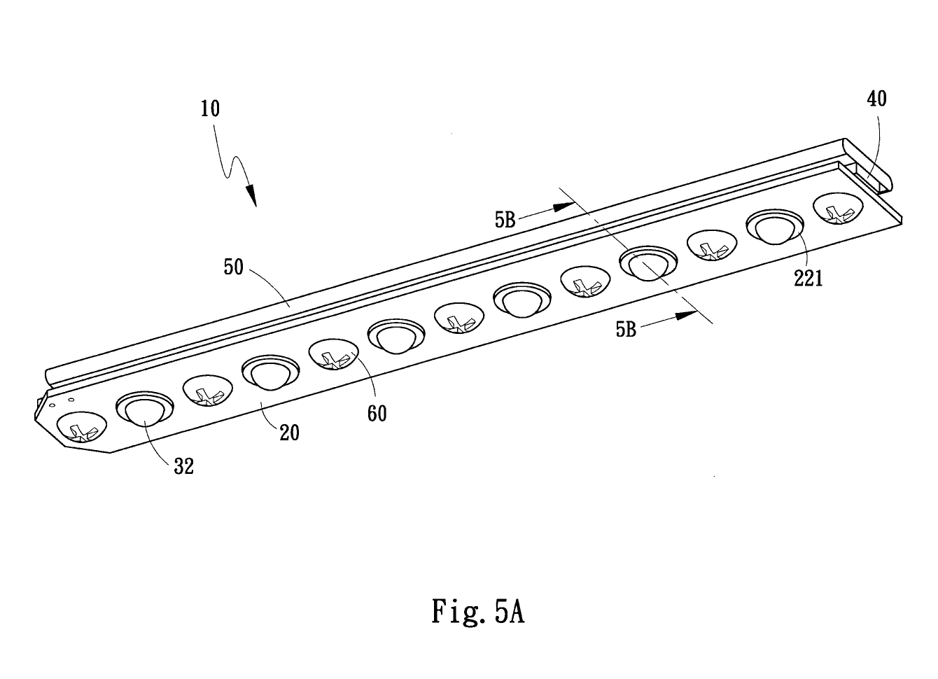

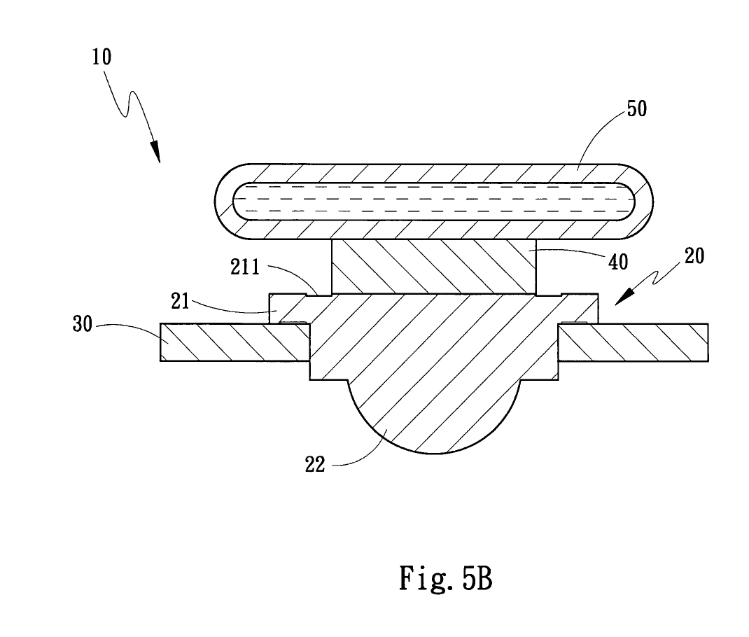

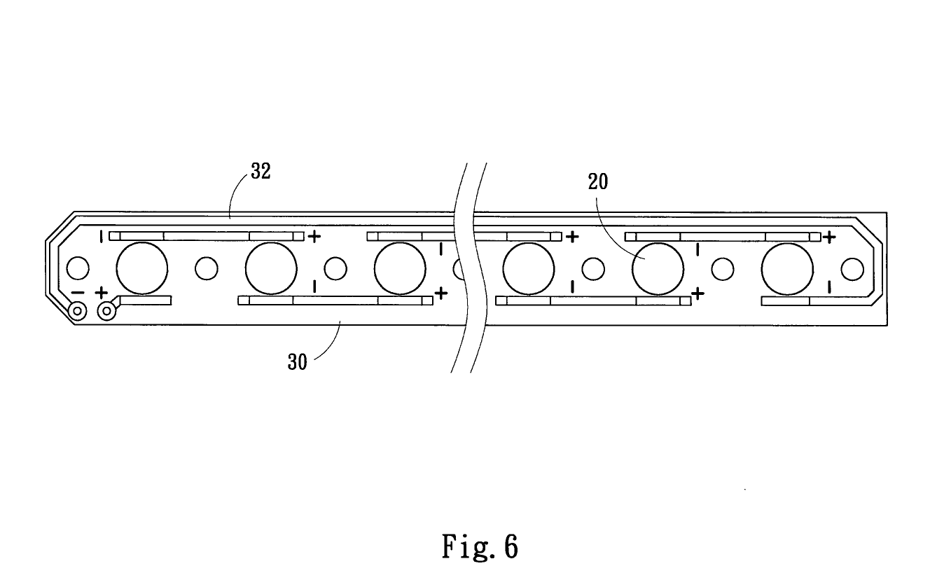

Refer to FIG. 2, FIG. 3, FIG. 4, FIG. 5A and FIG. 5B. In assembling the LED module 10 of the present invention, the LED lamps 20 are inlaid into the via-holes 31 of the baseplate 30 to make one side of the electrode plate 21 contact one side with the cascade circuits 32 of the baseplate 30. Next, one side of the heat-conduction block 40 is attached to the other side of the electrode plate 21 so that the heat generated by the LED lamps 20 can be conducted to the heat-conduction block 40. Next, the fixing elements 60 are inserted through the through-holes 33 of the baseplate 30 and fastened to the fixing holes 41 of the heat-conduction block 40 so that the baseplate 30 and the heat-conduction block 40 can be joined together. Then, the heat-conduction element 50 is attached to the other side of the heat-conduction block 40. Refer to FIG. 6. The cascade circuits 32 can be extended or shortened according to the number of the LED lamps 20.

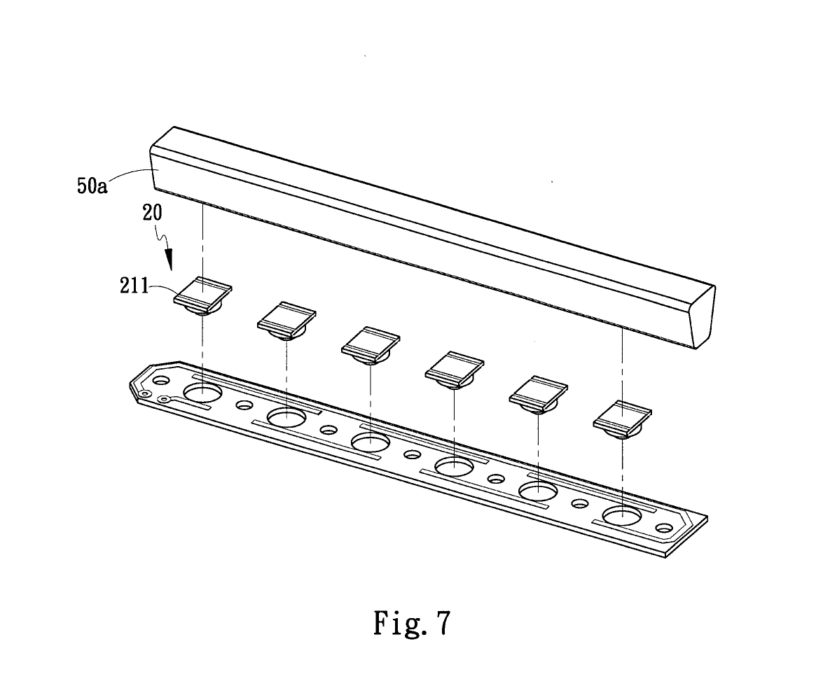

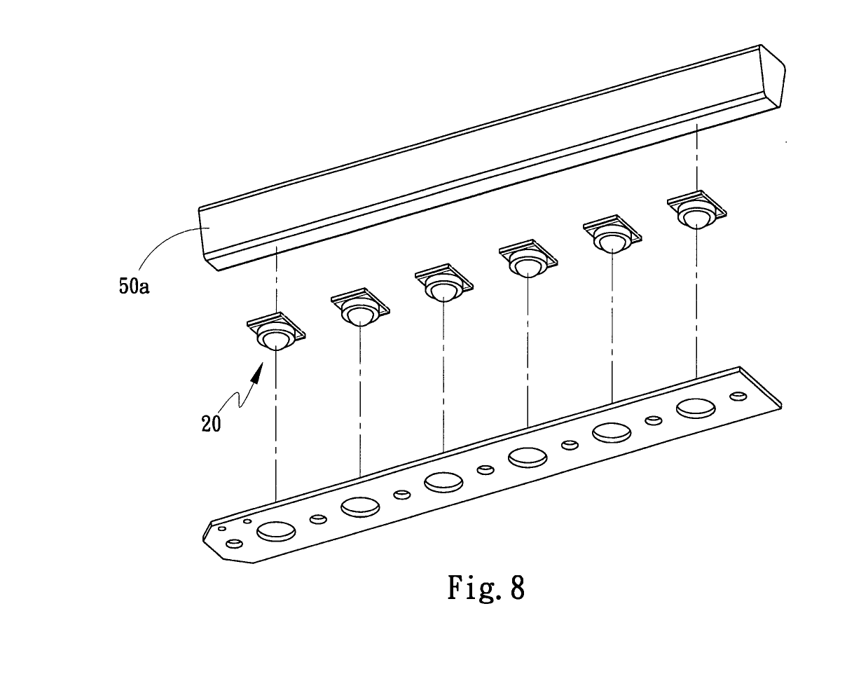

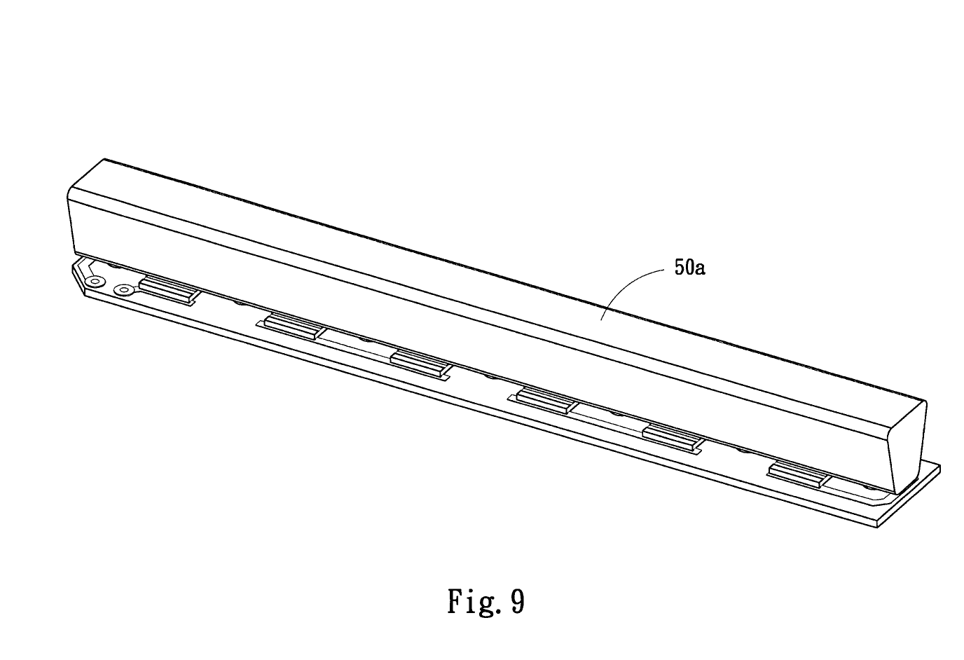

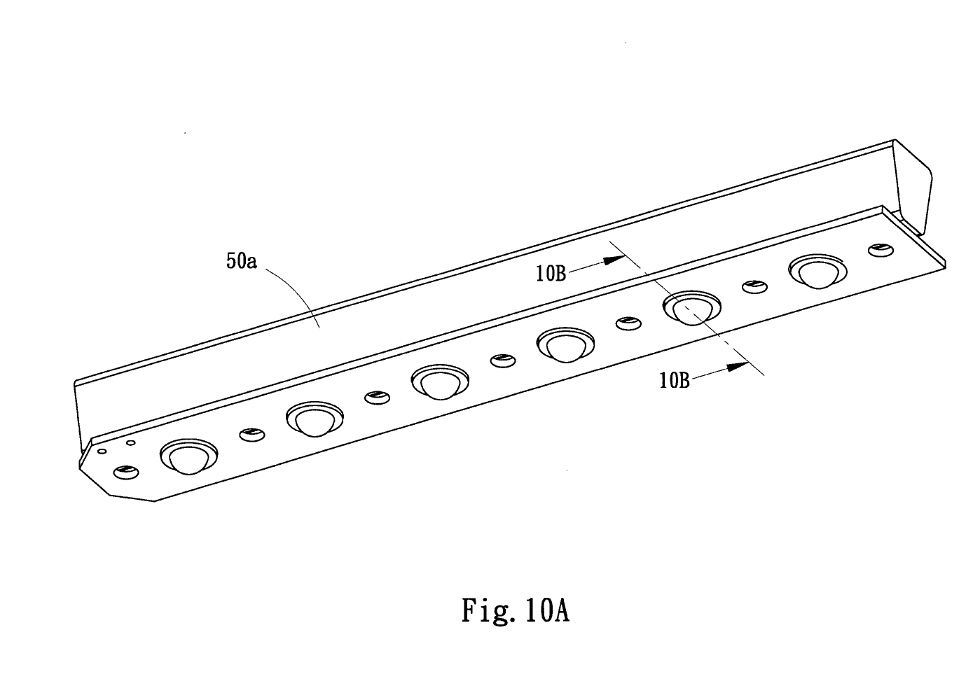

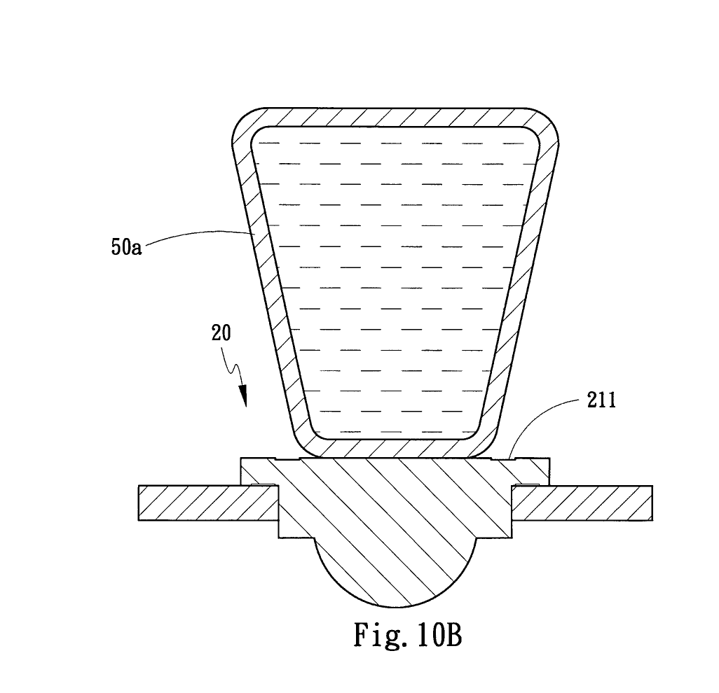

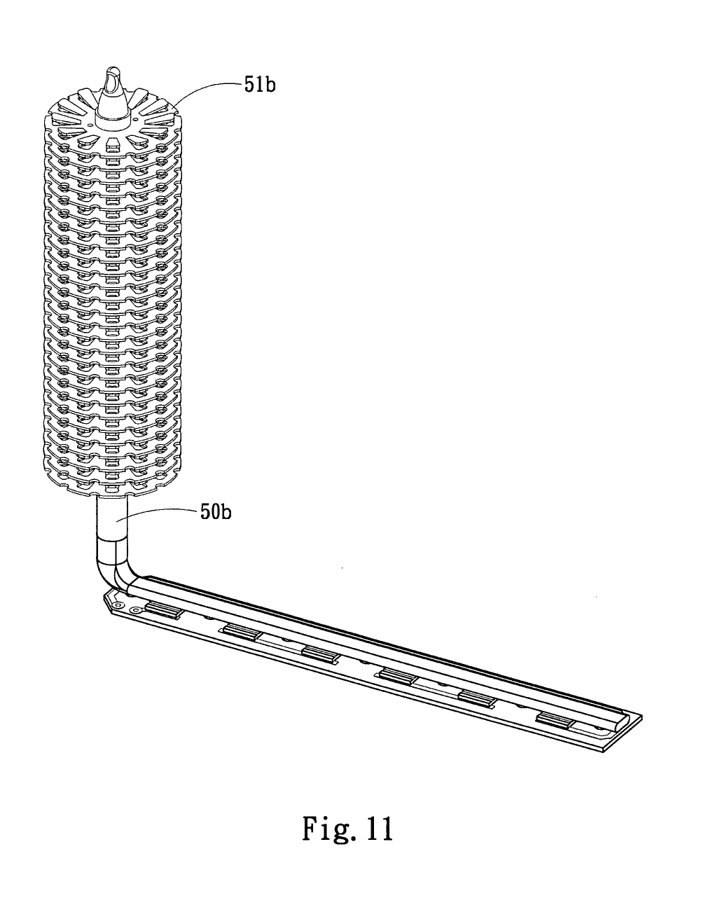

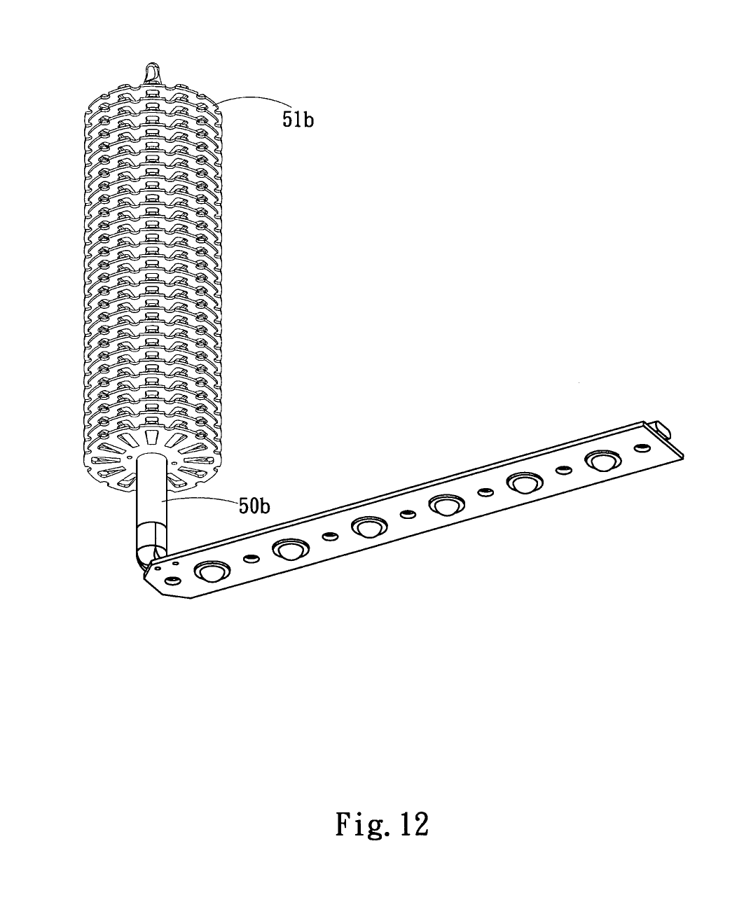

Refer to FIG. 7, FIG. 8, FIG. 9, FIG. 10A and FIG. 10B. The heat-conduction element 50a may be designed to have a section of another geometrical shape, such as a trapezoid shape so that one side of the heat-conduction element 50a can be directly attached to between two electrodes 211 of the electrode plate 21 of the LED lamps 20. Thus, the heat generated by the LED lamps 20 can be directly conducted to the heat-conduction element 50a. Thereby, not only heat conduction is more efficient, but also the heat-conduction block 40 is saved. Refer to FIG. 11 and FIG. 12. A plurality of heat-dissipation fins 51b may be installed in one side of the heat-conduction element 50b to dissipate the heat received by the heat-conduction element 50b. The fixing elements 60 may be screws, rivets, etc. Besides, the components can be joined together by welding or soldering without using any fixing element 60.

The LED module 10 of the present invention has the following improvements over the conventional LED modules:

1. In the conventional LED module, the LED lamp A10 is directly soldered onto the PCB A20. In other words, the heat source of the LED lamp A10 directly contacts the PCB A20. Thus, not only heat is hard to dissipate, but also it may overheat and damage the LED lamp A10. In the LED module 10 of the present invention, a heat-conduction block 40 is arranged on the LED lamps 20 and the baseplate 30. Thereby, the heat generated by the LED lamps 20 can be conducted and dissipated by the heat-conduction block 40 lest the LED lamps 20 be overheated and burned out.

2. In the conventional LED module, the PCB A20 has circuits A30 where the LED lamp A10 is soldered. The circuit A30 usually has a height of about several millimeters. After the LED lamp A10 is soldered onto the PCB A20, there is a gap of several millimeters between the LED lamp A10 and the PCB A20. An electric fan can blow air into the gap to dissipate heat. However, a gap of only several millimeters is unlikely to dissipate heat fast and effectively. In the LED module 10 of the present invention, the way of arranging the LED lamps 20 on the baseplate 30 is very different from that of the conventional LED modules. Refer to FIG. 5. Briefly to speak, the LED lamps 20 are placed into the via-holes 31 of the baseplate 30 inversely and then soldered onto the cascade circuit 32 of the baseplate 30. Such a design is very favorable to heat dissipation and very suitable for the direct type illumination.

What is claimed is:

1. A light emitting diode module, comprising: a plurality of LED (Light Emitting Diode) lamps, a plurality of baseplates, a plurality of heat-conduction blocks, a plurality of heat-conduction elements, and a plurality of fixing elements,
wherein said LED lamp has an electrode plate on one side thereof and has an LED on the other side thereof; one face of said electrode plate has two electrodes respectively arranged in two edges thereof, and said two electrodes are separated by an appropriate distance; a protection ring annularly surrounds said LED, and
wherein said heat-conduction block is a metal block having an appropriate thickness and a high thermal conductivity; said heat-conduction block is attached to one side of said electrode plate of said LED lamps and functions as a heat-conduction medium to dissipate heat generated by said LED lamps, and
wherein said heat-conduction block has a plurality of fixing holes, and said fixing elements are fastened into said fixing holes to join together said heat-conduction block and said baseplate, and
wherein said heat-conduction element is a heat-conduction body containing a heat-conduction liquid and attached to the other side of said heat-conduction block, and
wherein a plurality of heat-dissipation fins is installed in one side of said heat-conduction element to dissipate heat received by said heat-conduction element from said heat-conduction block, and
wherein said baseplate is a PCB (Printed Circuit Board) having circuits thereon; said baseplate has a plurality of via-holes, and said LED lamps are inlaid into said via-holes; said baseplate has cascade circuits to cascade said LED lamps to enhance brightness; said baseplate also has a plurality of through-holes, and said fixing elements are inserted through said through-holes to fasten said baseplate to said heat-conduction block.

2. The light emitting diode module according to claim 1, wherein the width of said heat-conduction block is equal to the distance between said two electrodes.

3. The light emitting diode module according to claim 1, wherein the inner diameter of said via-hole is slightly greater than the outer diameter of said protection ring of said LED lamp.

4. The light emitting diode module according to claim 1, wherein said cascade circuits may be arranged on both sides of said baseplate.

5. The light emitting diode module according to claim 1, wherein said baseplate are made of aluminum.

6. The light emitting diode module according to claim 1, wherein said cascade circuits can be extended or shortened according to the number of said LED lamps.

7. The light emitting diode module according to claim 1, wherein said heat-conduction element has a section of a trapezoid shape, which makes one side of said heat-conduction element directly attached to between said two electrodes of said electrode plate of said LED lamps.

8. The light emitting diode module according to claim 1, wherein a plurality of heat-dissipation fins is installed in one side of said heat-conduction element to dissipate heat received by said heat-conduction element.

9. The light emitting diode module according to claim 1, wherein said fixing elements are screws.

10. The light emitting diode module according to claim 1, wherein components of said module are joined together by soldering.
